(19) United States
(12) Patent Application Publication
(10) Pub. No.: US 2014/0228203 A1
(43) Pub. Date: Aug. 14, 2014

(54) MICROSPHERIC TIO2 PHOTOCATALYST

(71) Applicants: Nanyang Technological University, Singapore (SG); The Board of Trustees of The Leland Stanford Junior University, Palo Alto, CA (US)

(72) Inventors: Darren Delai SUN, Singapore (SG); Pei Fung LEE, Singapore (SG); James O. LECKIE, Stanford, CA (US)

(73) Assignees: Nanyang Technological University, Singapore (SG); The Board of Trustees of The Leland Stanford Junior University, Palo Alto, CA (US)

(21) Appl. No.: 14/257,700

(22) Filed: Apr. 21, 2014

Related U.S. Application Data
(62) Division of application No. 12/520,520, filed on Jan. 25, 2010, now abandoned.
(60) Provisional application No. 60/870,939, filed on Dec. 20, 2006.

(51) Int. Cl. B01J 21/06

(52) U.S. Cl. CPC B01J 21/063
USPC 502/8

(57) ABSTRACT

The present invention refers to titanium oxide microspheres having photocatalytic properties which can, for example, be used in a method for cleaning wastewater which uses a submerged membrane reactor.

### CROSS-REFERENCE TO RELATED APPLICATIONS

This application claims the benefit of priority of U.S. provisional application No. 60/870,939, filed Dec. 20, 2006, the content of which is hereby incorporated by reference in its entirety for all purposes.

### FIELD OF THE INVENTION

The present invention refers to titanium oxide microspheres having photocatalyst property which can be used in a process of cleaning wastewater which uses a submerged membrane reactor.

### BACKGROUND OF THE INVENTION

Contaminants present in raw water (e.g. natural organic matter (NOM) and bacteria) are detrimental to the water quality. There is a growing trend in the use of membrane technology for removal of such contaminants from raw water for the production of good quality potable water.

The “membrane” in a membrane reactor works as a filter which is based on the separation of substances depending on their size. With their micropores the membrane separates particles from the wastewater.

In recent years, membrane processes have become increasingly popular in water treatment for a variety of reasons which include prospectively more stringent water quality regulations, small footprint and reduced operation and maintenance costs due to advancements in membrane technology. One of the serious problems when utilizing filtration membrane in water treatment process is the decline of permeate flux due to membrane fouling and gel formation as learned from U.S. Pat. No. 5,505,841. In general, the membrane fouling can be defined as the accumulation of contaminated compounds on the surface of a membrane which form a solid layer. The solid layer on the surface of membrane comprises bacteria, organic and inorganic species, non-biodegradable compounds. Especially, the natural organic matter is suspected to be one of the major constituents in the solid layer causing the fouling problem in the membrane process (Sun, D. D., Li, J., et al., 2000, Civil Engineering Research Bulletin, NTU, Singapore, No.13). Thus, the term membrane fouling comprehensively refers to a series of phenomenon which comprise of pore adsorption, pore blocking or clogging, gel formation or cake formation.

Gel formation or cake formation specifically refer to the layer formed on the surface due to concentration polarization. The layer is formed at the membrane liquid interface where larger solute molecules excluded from the permeate form a coating. The fouling caused by solids or colloids deposited on the membrane surface, or gel formation or solid layer formation, is reversible and can be overcome by periodic membrane cleaning. However, the pore adsorption or pore blocking caused by colloids trapped within the pores is usually irreversible and requires membrane replacement.

To date, significant effort has been dedicated to control membrane fouling. Several physical membrane cleaning methods such as backwashing, aeration, ultrasonic cleaning (U.S. Pat. No. 7,008,540) have been suggested to minimize membrane fouling. In backwashing, permeation through the membranes is stopped momentarily. Air or water will flow through the membranes in a reverse direction to physically push solids off of the membranes. In aeration, bubbles are produced in the tank below the membranes. The bubbles will agitate or scrub the membranes and thereby remove some solids while creating an air lift effect and circulation of the tank water to carry the solids away from the membranes. In ultrasonic cleaning, ultrasonic energy is emitted by the ultrasonic transducer in the direction of the filtration membrane. Dislodged particles cleaned by the ultrasonic energy from the filtration membrane are carried away in a cross-flow stream.

These methods or combination of these methods are effective in removing the reversible membrane fouling like gel layer or solid layer.

On the other hand, chemical cleaning is applied to reduce or eliminate the irreversible membrane fouling. The permeation is stopped and a chemical cleaner is backwashed through the membranes. In some cases, the tank is emptied during or after the cleaning event so that the amount of cleaner can be collected and disposed of In other cases, if the tank remains filled, the amount of chemical cleaner is limited and subject to the tolerance for the application. Chemical cleaning has to be limited to a minimum frequency because repeated chemical cleaning may affect membrane life, and disposal of spent chemical reagents poses another problem. Thus the control of the irreversible membrane fouling is of importance for more efficient use of membranes.

For example, large molecular size of NOM is retained on the membrane surface while the small molecular size of NOM is trapped within the membrane pore which leads to irreversible membrane fouling that could not be cleaned by merely physical cleaning. Irreversible membrane fouling will eventually lead to higher long-term operating pressures, and thus, higher operating cost and more energy consumption.

Besides chemical cleaning of the membrane, it has been proposed to remove the contaminants from water prior to membrane filtration process to prevent irreversible membrane fouling. U.S. Pat. No 6,027,649 discloses a process capable of removing contaminants from water utilizing a coagulant in combination with a semi-permeable membrane. However this process is not effective for controlling irreversible fouling because such process does not remove trace organic matter or the smaller molecular size of NOM which will trap the membrane pores.

Powdered activated carbon (PAC) is proposed to be used in conjunction with membranes to remove organic contaminants by adsorption and allow the membrane to separate the larger PAC particles (U.S. Pat. No. 5,505,841; JP 2004 016 896). Several problems are encountered for the regeneration of PAC. PAC must be heated to high temperatures to burn off the NOM. The cost of regenerating at such high temperatures has a negative impact on the economics of the process using PAC. Further more, when PAC particles are heated to such high temperatures, a certain portion of PAC are consumed by combustion. At the end of PAC lifespan, they must be disposed of, which results in additional disposal costs. Moreover, the irregular shape of PAC may damage the surface of filtration membrane.

It has been proposed that freshly precipitated iron or aluminium oxides, common adsorbents, be used in conjunction with membranes to reduce fouling of the membrane. However iron oxide or aluminium oxide also requires heat treatment for regeneration. It is reported that the freshly precipitated particles themselves contribute to the fouling of the membrane. Heated iron oxide particles have been proposed to remove contaminants and concurrently reduce membrane fouling, the recondition process is carried out in acidic or basic condition to restore its adsorption capacity (U.S. Pat. No. 6,113,792). This method is not preferable for a continuous system.

Titanium dioxide is proposed to be used as adsorbent for the removal of contaminants due to its regenerative potential. The spent titanium dioxide can be regenerated via photocatalytic oxidation (PCO) process (Fang, H., Sun, D. D., et al., 2005, Water Science & Technology, vol.51, no.6-7, p.373-380). Commercial titanium dioxide, P25 is the most commonly used photocatalyst due to its high photocatalytic activity, chemical resistance, and low costs. Irradiation with light of sufficient energy creates the formation of electrons and holes on the surface of the photoreactive catalyst. The PCO process has been reported as a possible alternative for removing organic matters from potable water. A redox environment will be created in a PCO process to mineralize the NOM's and sterilize the bacteria adsorbed on the surface of the photocatalyst into carbon dioxide and water when the semiconductor photocatalyst is illuminated by light source (usually UV light) in a PCO process. The theoretical basis for photocatalysis in general is reviewed by Hoffmann, M. R., Martin, S. T., et al. (1995, Chem. Rev., vol 95, 69-96) and by Fox, M. A. and Dulay, M. T. (1993, Chem. Rev., vol.93, p.341-35′7).

Unfortunately, recycling and reuse of such P25 titanium dioxide is an existing problem, particularly separation of P25 titanium dioxide from treated water. Moreover, P25 titanium dioxide does not present individually in aqueous system, but rather as physically unstable complex primary aggregates ranging from 25 nm to 0.1 μm. These physically unstable complex aggregates would reduce the surface area/active sites and subsequently affect its photocatalytic activity (Qiao, s., Sun, D. D., et al., 2002, Water Science Technology, vol.147, no.1, p.211-217).

With the ever increasing concern about the quality of drinking water, there continues to be a need for improved systems for effectively and economically removing contaminants such as natural organic matter and bacteria from water.

### SUMMARY OF THE INVENTION

In a first aspect, the present invention refers to a titanium oxide microsphere having photocatalytic property and having a size of about 10 μm to about 200 μm and a mesoporous structure with a pore size in a range of about 2 to about 50 nm wherein the microspheres are obtained by the process comprising:
preparing a sol by mixing an organometallic titanium precursor with an alcohol without adding H₂O;
aging the sol;
mixing the aged sol with titanium oxide powder;
spraying the mixture to form the titanium oxide photocatalyst microspheres;
calcining the microspheres.

In another aspect, the present invention refers to a process of cleaning wastewater in a membrane filtration reactor, wherein the process comprises:
mixing the titanium oxide microsphere of the present invention with wastewater;
feeding the mixture into a membrane filtration reactor;
sucking the mixture treated in the membrane filtration reactor through the membrane, wherein the diameter of the microspheres in the mixture is greater than the diameter of the pores of the membrane, to form a cake layer of catalyst on the surface of the membrane; and
continuing feeding the membrane filtration reactor with wastewater until the wastewater is cleaned.

In still another aspect, the present invention refers to a submerged membrane reactor in which the titanium oxide microsphere of the present invention is mixed with wastewater cleaned in the reactor or which utilizes the process for cleaning waste water in a membrane filtration reactor of the present invention.

In a further aspect, the present invention is directed to the use of titanium oxide microspheres having photocatalytic property for operation of a submerged membrane reactor.

In another aspect the present invention is directed to a method of manufacturing a titanium oxide microsphere having photocatalytic property and having a size of about 10 μm to about 200 μm and a mesoporous structure with a pore size in a range of about 2 to about 50 nm wherein the method comprises:
preparing a sol by mixing an organometallic titanium precursor with an alcohol without adding H₂O;
aging the sol;
mixing the aged sol with titanium oxide powder;
spraying the mixture to form the titanium oxide photocatalyst microspheres;
calcining the microspheres.

### BRIEF DESCRIPTION OF THE DRAWINGS

The invention will be better understood with reference to the detailed description when considered in conjunction with the non-limiting examples and the accompanying drawings, in which:

FIGS. 1 and 2 show flow charts illustrating the separate steps for manufacturing the TiO₂ microspheres of the present invention. FIG. 2 illustrates a specific example which was carried out for manufacturing the TiO₂ microspheres of the present invention.

FIG. 3 shows SEM micrographs of a TiO₂ microsphere of the present invention at different magnifications. While the left picture shows a single microsphere the picture on the right side shows the surface of the TiO₂ microsphere of the present invention. The picture showing the surface demonstrates that the nano-size TiO₂ particles are uniformly distributed over the surface of the microsphere.

FIG. 4 shows the composition of the products used for preparing the TiO₂ microspheres of the present invention as well as the composition of the calcined TiO₂ microspheres. The composition products have been characterized by means of powder X-ray diffraction by using a Shimadzu XRD-6000 diffractometer with Cu_{KR} radiation. The top curve shows the XRD pattern for the calcined TiO₂ microspheres of the present invention while the middle and the lower curve show the XRD pattern for component A and B, respectively. The different peaks indicate crystalline phase of each product. TiO₂ crystallizes in three major structures: rutile, anatase and brookite. However only rutile and anatase play the role in the TiO₂ photocatalysis. Anatase phase, a stable phase of TiO₂ at low temperature (400-600° C.), is an important crystalline phase of TiO₂. Rutile is a stable phase of TiO₂ at high temperature (600-1000° C.). Hence the product has been calcined at 450° C. to obtain TiO₂ with anatase phase. The peak indicating the rutile phase in the manufactured microspheres shows the rutile phase TiO₂ contributed by the TiO₂ powder. The raw TiO₂ powder has in general a mixture of anatase and rutile at ratio of 70:30.

FIG. 5 shows a comparison of photocatalytic activity of TiO₂ microspheres of the present invention and commercial TiO₂ using phenol as targeted compound for cleaning (phenol concentration: 100 mg/l; photocatalyst mass concentration: 1 g/l, pH 7). FIG. 5 shows the degradation of phenol as a function of the irradiation time at pH 7. It can be observed that the degradation of phenol followed an exponential decay form. About 40% of phenol is degraded after 60 min of UV light irradiation with the absence of the TiO₂ microsphere of the present invention. The removal efficiency is greatly enhanced when the TiO₂ microsphere of the present invention is added into the solutions. The removal efficiency after 60 min UV light irradiation is 60% and 70% for P25 TiO₂ and nano-structured TiO₂ microsphere, respectively. It can be seen from FIG. 5 that the TiO₂ microsphere of the present invention possessed a better photocatalytic activity than P25 TiO₂. C/C₀ is the ratio of the concentration of microspheres in the samples to the initial concentration of those microspheres.

FIG. 6 shows an exemplary set up of a reactor system using the TiO₂ microspheres of the present invention. Raw water is introduced into the membrane reactor tank through a valve. Within the membrane reactor tank the raw water is mixed with fresh TiO₂ microspheres of the present invention and recycled TiO₂ microspheres from the PCO reactor. Within the reactor tank the raw water and the TiO₂ microspheres are mixed by the turbulence flow created by coarse diffuser located at the bottom of the membrane reactor. As can be seen in FIG. 6 the coarse diffusers are connected to an air supply which is also connected to the PCO reactor. After cleaning the wastewater is passed through the pores of the filtration membrane by suction force generated by a pump located outside the membrane reactor. The TiO₂ microspheres settle to the bottom of the membrane reactor once the coarse diffuser stops working From the bottom of the membrane reactor they are transferred via a pump into the PCO reactor. The PCO reactor consists of a reaction chamber and a UV lamp. The PCO chamber consists of a double glass-cooling jacket (e.g., o.d. 70 mm for the outer wall, i.d. 50 mm for the inner wall and height of 350 mm). The PCO reactor can be fitted with a gas diffuser at the bottom of the PCO chamber for diffusing the air. A medium-pressure mercury lamp (12 W) with primary emission wavelength of 253.7 nm is installed vertically in the middle of the reactor as the UV source (see also Fang, H., Sun, D. D., et al., 2005, supra).

FIG. 7 shows the graphical illustration of the effect of titanium dioxide microspheres on permeates flux through a membrane. The initial permeate flux of humic acid filtration is 3.3 l*min⁻¹*m⁻² and gradually decreased to 2.3 l*min⁻¹*m⁻². There is a flux decrease of 30% after 300 min of humic acid filtration. The initial permeate flux is increased with the presence of TiO₂ microsphere in solution. The initial permeate flux is enhanced to about 5.0 l*min⁻¹*m⁻² with the presence of 0.5 g/L of TiO₂ microsphere in humic acid solution. The permeate flux dropped to 4.2 l*min⁻¹*m⁻², about 16% of flux drop after 300 min of filtration. However when the concentration of TiO₂ microsphere increased to 1 g/L, the initial permeate flux is reduced to 4.2 l*min⁻¹*m⁻². Hence, the increase of TiO₂ concentration in solution affects the degree of flux enhancement. In general the presence of TiO₂ microsphere in solution is still beneficial in enhancing the permeate flux.

FIG. 8 shows the graphical illustration of the permeate quality during the membrane filtration process. The permeate quality shows that the membrane filtration is able to remove humic acid to about 75%. The removal rate of humic acid can achieve 87% and 93% with the presence of 0.5 g/L and 1.0 g/L of TiO₂ microsphere, respectively. The increase of TiO₂ concentration in solution will help to achieve a better removal rate.

FIG. 9 shows the pore size distribution of TiO₂ microsphere and P25 TiO₂. Pore size distribution curve was calculated from the adsorption branch using the BJH (Barrett-Joyner-Halenda) method. In FIG. 9, Dv, cc/nm/g (Dv stands for pore volume, and cc stands for cubic centimeters) has been plotted against the pore diameter in nm. The total pore volumes were estimated from the amounts adsorbed at a relative pressure (P/P0) of 0.99. The first peak in FIGS. 9 of 2 to 3 nm pore size is referred to intercrystalline porosity which is the pore within the TiO₂ microsphere or the P25 TiO₂ agglomerates. The pore sizes obtained with the method of the present invention for manufacturing the TiO₂ microspheres of the present invention lies in the mesoporous range (2-50 nm) whereas, for example, the microspheres manufactured according to Li, X. Z. and Liu, H. (2003, Environ. Sci. Technol., vol.37, p.3989-3994) lies in the mesoporous range as well as in the macroporous range (>50 nm). The second peak refers to the interagglomerate pore which is the pore between the TiO₂ microspheres or the agglomerated P25 TiO₂. A smaller pore size distribution, i.e. the smaller mesoporous structure, of about 2 to 50 nm enhances the adsorption of contaminants.

### DETAILED DESCRIPTION OF THE INVENTION

Considering the continuous need for improved systems for effectively and economically removing contaminants such as natural organic matter and bacteria from water the inventors have developed titanium oxide microspheres having photocatalytic property or activity and having a size of about 10 μm to about 200 μm and a mesoporous structure with a pore size in a range of about 2 to about 50 nm. This microspheres are obtained by a process which comprises:
preparing a sol by mixing an organometallic titanium precursor with an alcohol without adding or using H₂O;
aging the sol;
mixing the aged sol with titanium oxide powder;
spraying the mixture to form the titanium oxide photocatalyst microspheres;
calcining the microspheres.

The manufacture of those particles is based on the sol-gel process. In general, the sol-gel process is based on the phase transformation of a sol obtained from metallic alkoxides or organometallic precursors. This sol, which is a solution containing particles in suspension, is polymerized at low temperature to form a wet gel. The wet gel is going to be densified through a thermal annealing to give an inorganic product like a glass, polycrystals or a dry gel. In general, the sol-gel process consists of hydrolysis and condensation reactions, which lead to the formation of the sol.

A “sol” is a dispersion of solid particles in a liquid where only the Brownian motions suspend the particles. A “gel” is a state where both liquid and solid are dispersed in each other, which presents a solid network containing liquid components.

The terms “particle”, “microparticle”, “bead”, “microbead”, “microsphere”, and grammatical equivalents refer to small discrete particles, substantially spherical in shape, having a diameter of about 10 micrometers (μm) to about 200 micrometers. The average size of the titanium oxide microspheres referred to herein is about 50 μm.

The sol-gel process used in the present invention can be performed according to any protocol. The titanium oxide microspheres may be formed from an organometallic titanium precursor, for example in situ during the reaction process.

In this process, at first the sol may for instance be generated by hydrolysis of such a precursor. An exemplary precursor can be a titanium alkoxide. The hydrolysis of a titanium alkoxide is thought to induce the substitution of OR groups linked to titanium by Ti—OH groups, which then lead to the formation of a titanium network via condensation polymerisation. Examples of titanium alkoxides can include, but are not limited to titanium methoxide, titanium ethoxide, titanium isopropoxide, titanium propoxide and titanium butoxide.

Typically, but not limited thereto, sol preparation by hydrolysis and condensation of a titanium alkoxide can be performed in an alcohol or an absolute alcohol. Any alcohol can be used in the present method. Examples of alcohols which can be used are ethanol, methanol, isopropanol, butanol or propanol.

In general the hydrolysis does not require the use of a catalyst. However, using a catalyst can accelerate the proceeding. Thus, in one aspect, the present invention further comprises adding a catalyst to the sol for initiating the reaction between the precursor and the alcohol. Any known acidic catalyst, such as hydrochloric acid or nitric acid, can be used. In an acid-catalyzed condensation, titanium is believed to be protonized which makes the titanium more electrophilic and thus susceptible to nucleophilic attack. In an acid-catalysed process, the pH value may for instance be in the range of about 1 to about 4, such as for example about pH 1 or 2 or 3 or 4.

The ratio of the organometallic titanium precursor to alcohol can be about 1 to between about 4 to 100 mol. In one example the ratio is about 1 to between about 40 to 60 mol.

Afterwards, the reaction mixture of titanium precursor and alcohol and optionally the catalyst is aged. With “aging” it is meant that the gel which starts to form from the sol shrinks in size by expelling fluids from the pores of the aging sol. Aging can take from 24 hours up to 2, 3 or 4 days. In the present invention the sol is aged for about 24 hours before it is used for mixing with a titanium oxide powder.

For the manufacture of the titanium microspheres of the present invention no water (H₂O) is used for sol preparation because water would accelerate the gelation process and the precipitation of Ti(OH)₂ in sol. “Precipitation” means that the sol already precipitates to solids. That means that the present invention uses the “sol” condition during the synthesis process so that the sol will serve like a “glue” function to give a strong binding capacity to form the microspheres during the later following spray drying process. Hence, without the use of water a much more stable sol can be obtained having a shelf life of more than 1 year. With longer “shelf life” is meant that the sol will not undergo any changes during the period of storage and can be later used for the next step in the process, namely mixing the sol with titanium oxide powder and spray drying.

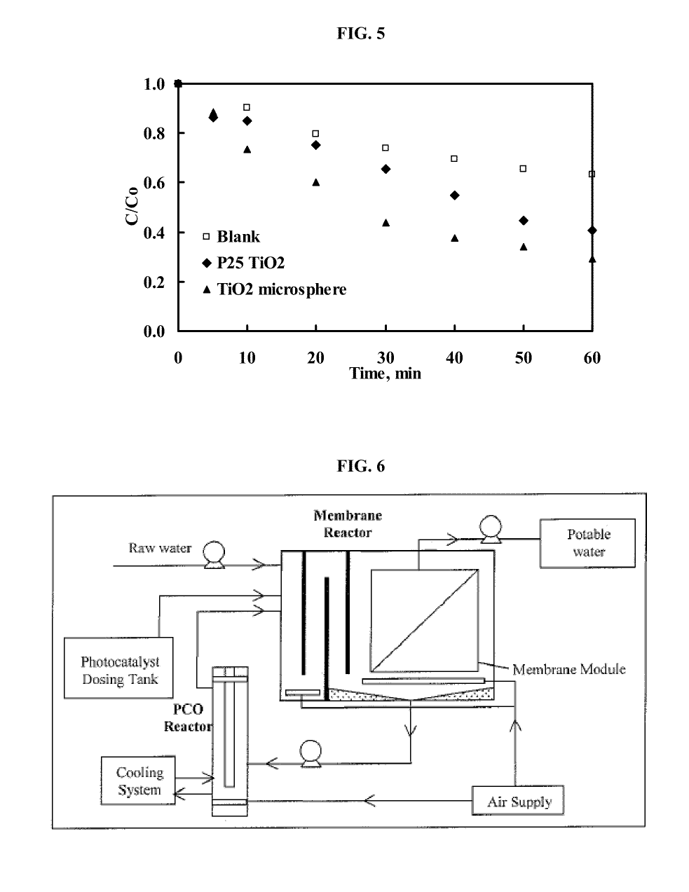

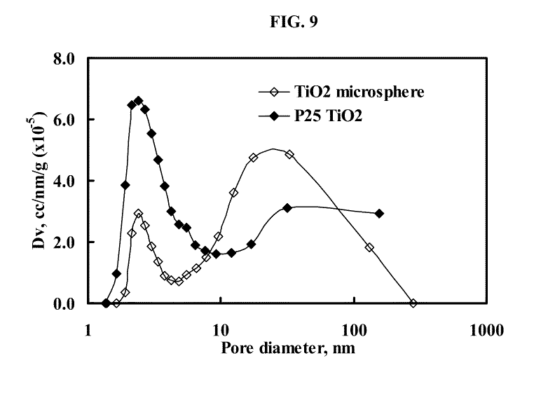

Another advantage of not using water is that the spray drying process can be operated at lower temperatures when alcohol is used instead of water. Another effect is that the microspheres of the present invention show a mesoporous structure, i.e. a pore size distribution of between about 2 nm to 50 nm (FIG. 9). In general, a mesoporous pore size distribution enhances the adsorption of contaminants (Lorenc-Grabowska, E. and Gryglewicz, G., 2005, Journal of Colloid and Interface Science, vol.284, p.446-423). The enhanced cleaning capacity for microspheres having such a pore size distribution has also been demonstrated for the microspheres of the present invention (see FIGS. 5 and 8).

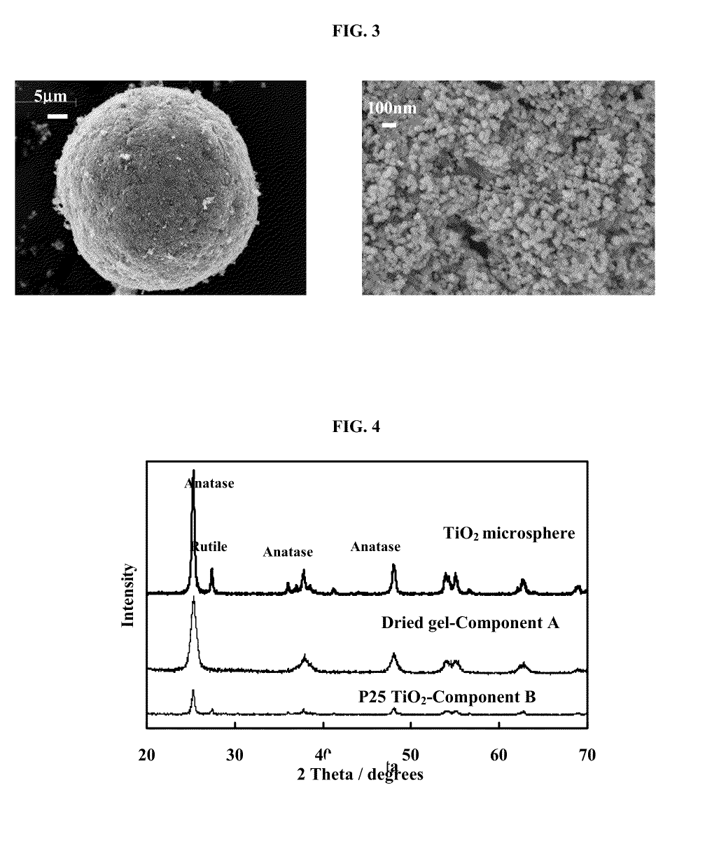

In the process of obtaining the TiO₂ microspheres of the present invention illustrated in FIG. 3, the use of additive or templates should also be avoided during the preparation of the sol. In general, additives or templates will contribute to the unstability of the sol which means that the shelf life of the particles will be limited. Additives, like polyethylenglycol (PEG), polyvinyl acolhol (PVA) and carboxymethylcellulose (CMC) are normally used to create the pore structure of a product, like for example a microsphere. Higher molecular weight of an additive will lead to larger pore sizes once the additive is decomposed (Antonietti, M., 2001, Current Opinion in Colloid and interface Science, vol.6, issue 3, p.244-248). Another problem that was found is that those additives or templates are sometimes difficult to remove during the calcination process. In this case, this would affect the degree of crystallinity of the TiO₂ microspheres which is important for their cleaning capabilities. Different additives or templates might have different decomposition temperatures and therefore might not compromise with the optimum calcination temperature for phase transformation of TiO₂ into the anatase type especially if the low temperature to form anatase phase (400° C.) is used. In the process of obtaining the TiO₂ particles, amphipilic three-block copolymers, additives like for example polyethyleneglycol (PEG), PVA and CMC are not added to the sol as it is done for example in the method described in CN 1443601 A which was used by Li, X. Z. and Liu, H. (2003, supra).

After aging, titanium oxide powder is mixed into the aged sol. Any titanium oxide powder can be used. In one example described herein, titanium oxide powder supplied by Degussa, Germany, has been used. This powder is characterized by comprising a surface area of about 50 m⁻² g⁻¹, having a crystal size of about 30 nm and about 70% of this TiO₂ crystals are of anatase type. Another TiO₂ powder which could also be used is supplied by Taixing Nano-Materials Company in China. Their powder is characterized by comprising a surface area of about 56.7 m⁻² g⁻¹, having a crystal size of about 9.6 nm and about 89.4% of this TiO₂ crystals are of anatase type.

Different weight ratios are possible for mixing titanium oxide powder with the aged sol. The minimal ratio is about 1:3 whereas the maximal ratio is about 1:10. In one example, the weight ratio for mixing aged sol with titanium oxide powder is about 1:5. Mixing is carried out using any method for mixing known in the art, for example, under stirring conditions using a magnetic stirrer for obtaining mixed slurry.

The slurry obtained after mixing is then sprayed to form the titanium microspheres. During spray drying the particles aggregate to form semisolid microspheres.

After spraying the microspheres are calcined to form solid TiO₂ microspheres. Calcination reactions usually take place at or above the thermal decomposition temperature (for decomposition and volatilization reactions) or the transition temperature (for phase transitions) of the metalloxide used. The calcination step has the effect that the TiO₂ particles obtained by spraying are transformed from amorphous phase to crystallite phase of anatase type. The different composition of crystal types of the different components used for the manufacture of the TiO₂ microspheres are illustrated in FIG. 4.

In general, calcination is carried out at a temperature between about 400° C. to about 600° C. Calcination can be carried out at a temperature of about 400° C. as well as at 500° C. In one example, the temperature was about 450° C. Calcination is carried out for several hours, for example 3, 4, 5 or 6 hours. Calcination is normally carried out in furnaces or reactors (sometimes referred to as kilns) of various designs including shaft furnaces, rotary kilns, multiple hearth furnaces, and fluidized bed reactors. The phase transformation might also be induced using the hydrothermal method as described by Hildago et al. (2007, Catalysis Today, vol.129, p.50-58). Using the hydrothermal method, the sample is placed in a Teflon recipient inside of a stainless steel autoclave. Hydrothermal treatment is performed at a low temperature, for example 120-150° C. for several hours up to 24 hours and at high working pressures, for example 198.48 to 475.72 kPa.

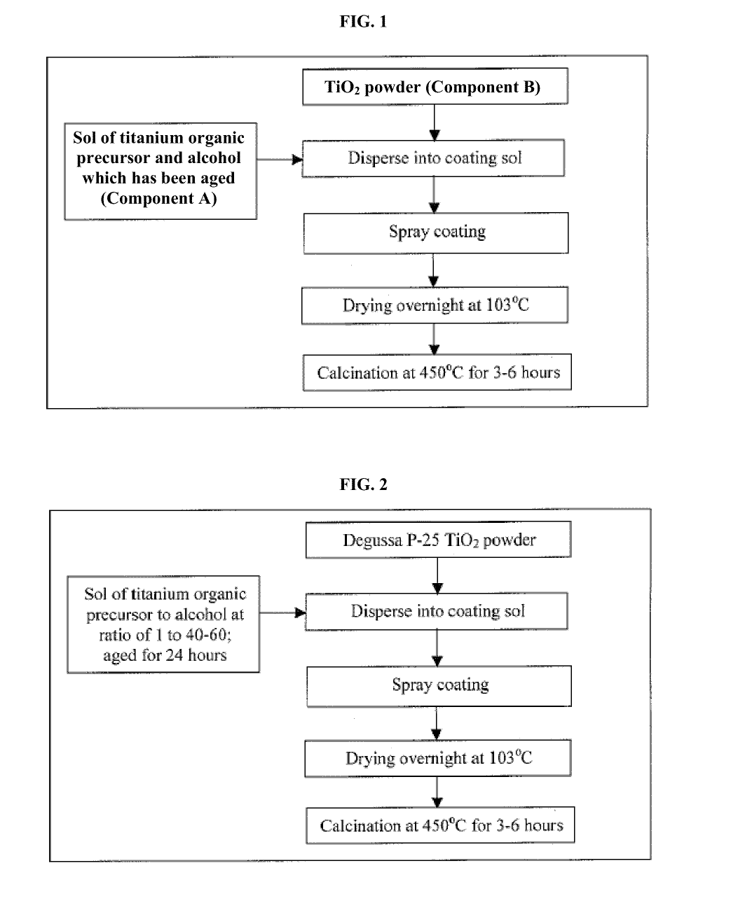

As an optional step, the TiO₂ particles obtained after spraying can be dried before calcination to allow further condensation and passing off of remaining liquids (water, alcohol) from the gel. Depending on the liquid content in the wet-gel, the drying step can be carried out for about one night up to several days. In one example, of the present invention, the TiO₂ particles have been dried overnight. The particles can either be dried at room temperature or at a temperature between about 50 to about 150° C. FIGS. 1 and 2 show a general overview of the process of obtaining the TiO₂ particles of the present invention.

Table 1 illustrates the physical characteristics of TiO₂ microspheres of the present invention and a pure TiO₂ powder, namely P25 from Degussa, Germany.

TABLE 1

| | BET Surface | Total pore |
|---|---|---|
| Sample | Area (m²/g) | volume (cm³/g) |
| P25 TiO₂ Component B | 43.74 ± 5.02 | 0.952 ± 0.245 |
| particle size 25 nm to 0.1 μm | | |
| TiO₂ microspheres | 41.89 ± 3.98 | 0.472 ± 0.092 |
| particle size 10-200 μm | | |

Even though the TiO₂ microspheres of the present invention are much larger than commonly used TiO₂ particles, like P25, the BET surface is retained due to its mesoporous structure. According to the definition of the International Union of Pure and Applied Chemistry (IUPAC) the term “mesopore/mesoporous” refers to pore size in the range of 2 to 50 nm and this range enhances the adsorption of contaminants (see FIG. 8) (Lorenc-Grabowska, E. and Gryglewicz, G., 2005, supra). According to IUPAC, a pore size below 2 nm is termed a micropore range and >50 nm is termed macropore range.

Thus, the pore size of the microspheres of the present invention falls into the mesoporous range only. For example, the pore size of the microspheres mentioned by Li, X. Z. and Liu, H. (2003, supra) ranges between the mesoporous and macroporous range and depends on the additives used. Li, X. Z. and Liu, H. (2003, supra) uses another mechanism for forming the porous structure of their microspheres. Li, X. Z. and Liu, H. (2003, supra) use the additives (i.e. PEG) to create the porous structure. In the present invention, the nanosized TiO₂ powder (from the sol) is embedded within the microsphere in order to create the interconnected pore structure of the microspheres. This has the effect that the pore size distribution of 2 to 3 nm which is the intercrystalline pore within the TiO₂ microspheres, is 0.3 whereas the pore size distribution of Li, X. Z. and Liu, H. (2003, supra) is 0.7.

The photocatalytic activity of the microspheres of the present invention is improved due to the quantum size effect which is triggered by the embedded nano-sized anatase crystallites as illustrated in FIG. 5. Quantum size effect is a phenomenon which occurs for semiconductor particles on the order of 1-10 nm in size. Particles which fall within this range will have increased photoefficiencies as described by Linsebigler, A. L., Lu, G. and Yates, J. T. Jr (1995, Chem. Rev., vol.95, pp.735-758).

As can be seen from FIG. 3 the particles of the present invention have a very regular spherical shape and thus surface damage of filtration membranes in a reactor is avoided. Those TiO₂ microspheres can also be used to avoid irreversible membrane fouling because they inhibit, for example, that small particles dissolved in wastewater clog the pores of the filtration membranes.

Therefore, the present invention is also directed to a process of cleaning waste water in a membrane filtration reactor, wherein the process comprises:
mixing the titanium oxide microsphere of the present invention with wastewater which is to be treated in a membrane reactor;
filtering the mixture treated in the membrane filtration reactor through the filtration membrane of the membrane filtration reactor by applying a suction force at the filtration membrane of the membrane reactor, wherein the diameter of the microspheres in the mixture is greater than the diameter of the pores of the membrane, to form a cake layer of microspheres on the surface of the filtration membrane; and
continuing feeding the membrane filtration reactor with wastewater until the wastewater is cleaned.

In one example the process further comprises adding more titanium oxide microspheres into the membrane reactor when further wastewater is fed into the membrane filtration reactor.

“Wastewater” “raw water” or “sewage” includes municipal, agricultural, industrial and other kinds of wastewater. In general, any kind of wastewater can be treated using the process of the present invention. In one example, the wastewater has a total organic carbon content (TOC) of about 20 mg/l. In one example, the wastewater used in the method of the present invention has already been treated to remove trace organics or soluble organics from the wastewater.

If necessary, this process can comprise further mixing of the mixture of TiO₂ microspheres and wastewater to achieve a uniform distribution of the microspheres in the wastewater. FIG. 6 illustrates the possible setup of a membrane reactor which uses the microspheres of the present invention. A good mixture of microspheres with wastewater can be achieved in membrane reactor tank by turbulence flow created, for example, by coarse diffuser located at the bottom of the membrane reactor.

In general, the microspheres are used for removal of NOM and bacteria from water. The nano-structured microspheric titanium dioxide photocatalysts are combined with the incoming raw water to form a suspension. Combination of wastewater and microspheres can take place before entering the membrane reactor shown in FIG. 6 or only upon entering the membrane reactor.

After mixing, the nano-structured microspheric titanium dioxide photocatalysts remove NOM and bacteria from water by adsorption (Fang, H., Sun, D. D., et al., 2005, supra). An immersed filtration membrane is used for separating the potable water from the nano-structured microspheric titanium dioxide photocatalyst suspension. Wastewater treated with the microspheres is passed or filtered through the membrane as permeate when suction force is applied to the filtration membrane.

The composition of the membrane and the size of the pores of the membrane may vary over a wide range, depending on the particular contaminants that are to be removed from the wastewater. Such membranes are usually submerged membranes. Such membranes can include those known in the art and which are used in microfiltration, ultrafiltration and nanofiltration systems. The pore size of such membranes is can be in the range of 0.001 to 0.1 μm. Such membranes can be made of ceramics or polymers.

Examples of polymers which are used for filtration membranes are cellulose acetate, polyamide, polysulphone, polypropylene, polytetrafluoroethylene (PTFE). Examples of ceramics which are used for such filtration membranes are diatom earth, aluminium oxide, titanium oxide, titanium dioxide or zinc oxide. In one non-limiting example of the present invention, the membrane is made of ceramics, namely diatom earth of the MF type (Doulton, USA).

The TiO₂ microspheres can adsorb the contaminants from wastewater due to its mesoporous structure. The particle size of the nano-structured microspheric titanium dioxide photocatalyst is preferred to be larger than the membrane pore to prevent clogging or irreversible fouling. Thus, a dynamic layer of photocatalyst is formed on the membrane surface due to suction force at the membrane which prevents the remaining portion of contaminants from water to trap within the pores of the filtration membrane. Water to be treated is continuously introduced into the tank and continued until predetermined hydraulic retention time to reach the adsorption equilibrium or the reduction in the degree of NOM removal or reduction in permeate flow is observed.

At this point, the permeation can be stopped and the membrane can be backwashed to remove the layer of spent microspheres that formed on the surface of the filtration membrane in the membrane reactor. During and/or after the backwashing step, a tangential flushing can be carried out in order to flush out the inner surface of the filtration membrane and recover the microspheres.

The spent titanium dioxide microspheres can be regenerated via PCO process (Fang, H., Sun, D. D., et al., 2005, supra). Therefore, the spent adsorbent is directed to a PCO reactor as indicated in FIG. 6. The photocatalyst is activated by UV light at 254 nm, electron and hole charge carrier pairs are produced within the photocatalyst microspheres. These charge carriers then perform oxidation/reduction (redox) reactions with the adsorbed species on the surface of photocatalyst. NOM is oxidized and bacteria are sterilized by the PCO process. A hydraulic retention time is provided for the regeneration to restore the adsorption capacity of the microspheric TiO₂ photocatalyst. The regenerated microspheric TiO₂ photocatalyst can than be recirculated back to the membrane reactor as shown in FIG. 6.

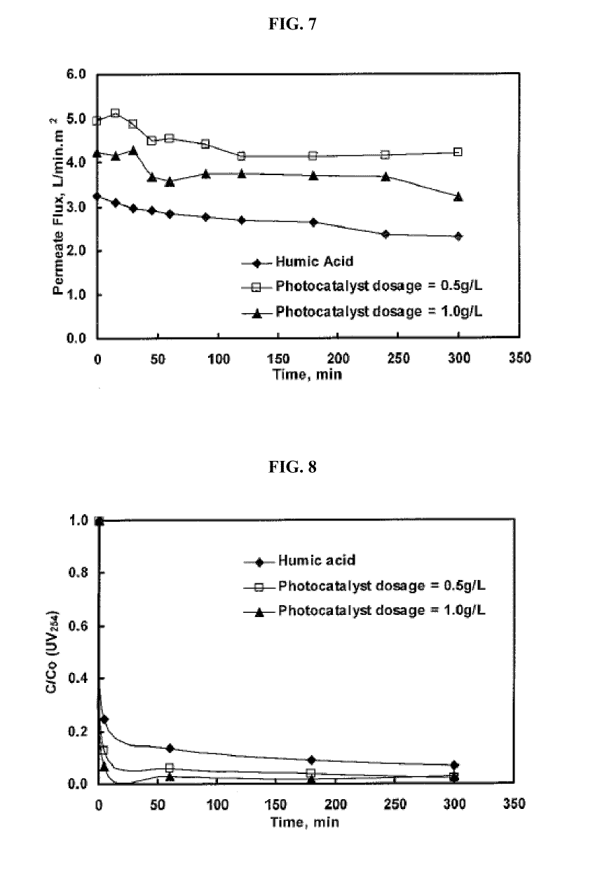

The integrated system of membrane filtration and PCO is a very efficient and cost-effective technology for the removal of NOM and bacteria from water. An important factor that determines the economics of this process is the increase of permeate flux in both quality and quantity, and the extended membrane lifespan that could be achieved due to the use of the TiO₂ microspheres which avoid membrane fouling. The permeate flux is enhanced by factors of 1.5 when the microspheric titanium dioxide photocatalyst is added to the wastewater as can be seen from FIG. 7. The permeate quality is improved as well as is illustrated by FIG. 8.

In another aspect, the present invention is also directed to a method of manufacturing a titanium oxide microsphere having photocatalytic property, having a size of about 10 μm to about 200 μm and a mesoporous structure with a pore size in a range of about 2 to about 50 nm. This method comprises:
preparing a sol by mixing an organometallic titanium precursor with an alcohol without adding H₂O;
aging the sol;
mixing the aged sol with titanium oxide powder;
spraying the mixture to form the titanium oxide photocatalyst microspheres;
calcining the microspheres.

By “consisting of” is meant including, and limited to, whatever follows the phrase “consisting of”. Thus, the phrase “consisting of” indicates that the listed elements are required or mandatory, and that no other elements may be present.

In another aspect, the present invention is directed to a submerged membrane reactor in which the titanium oxide microspheres of the present invention are mixed with the wastewater cleaned in the reactor or which utilizes the process of the present invention.

In another aspect, the present invention refers to the use of titanium oxide photocatalyst microspheres of the present invention for operation of a submerged membrane reactor.

By “comprising” it is meant including, but not limited to, whatever follows the word “comprising”. Thus, use of the term “comprising” indicates that the listed elements are required or mandatory, but that other elements are optional and may or may not be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### EXAMPLES

### Manufacture of TiO₂ microspheres

In a non-limiting example of the present invention, the coating sol is prepared by dissolving 6.8 mL of tetra-n-butylorthotitanate [Ti(OC₄H₉)₄], obtained from Merck in 58.2 mL of absolute alcohol (CH₃CH₂OH), obtained from Fluka. A uniform TiO₂ sol is formed as component A under vigourous mixing. During this process, pH is monitored and kept around 3 by the addition of 0.5 mL of concentrated hydrochloric acid (HCl). The sol is aged for at least 24 hours by leaving it alone in a sealed bottle before further use. Then the commercial TiO₂ powder (anatase=70%, surface area=50 m⁻² g⁻¹, and crystal size=30 nm) supplied by Degussa, Germany is used as component B and mixed with component A at a powder:sol ratio of 5:1 by weight to form a slurry. Then the slurry is put into a spray dryer (capacity 1500 ml/h) with inlet air at 30° C. and outlet air at 30° C. In the spray dryer, the TiO₂ particles aggregate to form semisolid microspheres. Finally the semisolid microspheres are calcined at higher temperature of 450° C. for 3 h to form solid TiO₂ microspheres No water or any additive has been used in the preparation of these TiO₂ microspheres.

### Characterization of TiO₂ Microspheres

Humic acid (HA) used in this study is obtained from Fluka Chemical. Humic acids in water are harmful compounds with a complex nature composed of carboxylic, phenolic and carbonyl functional groups. These substances cause a brown-yellow color in water and are known to be the precursor of carcinogenic halogenated compounds formed during the chlorination disinfection of drinking water. A concentrated HA solution is first prepared by mixing 4 grams of HA and 50 ml of 1 M NaOH in approximately 1.5 litres of pure water for at least 30 minutes with a magnetic stirrer. When completely mixed, the solution was diluted to 2 l in a volumetric flask. The solution was filtered through a 0.45 μm membrane filter. The HA concentrated solution was refrigerated and used as needed. The concentrations of HA in this study were obtained by diluting the concentrated solution. The pH of the solution was adjusted by HCl and NaOH with a calibrated pH meter.

Different TiO₂ dosages are used together with this solution of humic acid, at fixed transmembrane pressures (0.3 Mpa). The humic acid is prepared at 20 ppm concentration, with 50 ppm of Ca²⁺, at a pH of 7. Polysulfone membrane with molecular weight cut-off 50k is used in the membrane filtration study. The filtration study is carried out using a lab-scale membrane filtration unit supplied by Nitto Denko with a maximum operating pressure at 0.6 Mpa. The flowrate, flux (for the permeate) and pH (the permeate and feed) is recorded every 15 mins for the first hour, every 30 mins in the second hour and every one hour from the third hour till the fifth hour. FIG. 7 shows the graphical illustration of the effect of titanium dioxide particles on permeates flux through a membrane. Samples of permeate are also collected during the operation. The optical absorption spectrum on the HA is determined by a Perkin Elmer (USA) Lambda Bio 20 spectrophotometer. The absorbance at 400 nm is selected for quantitative analysis of color. FIG. 8 shows the graphical illustration of the permeate quality during the membrane filtration process.

A PCO test is carried out to compare the photocatalytic activity of nano-structured TiO₂ microspheres of the present invention and commercial P25 TiO₂ under the same conditions. Phenol (analytical grade) with an initial concentration of 100 ppm was chosen as the targeted compound. The choice of this compound was motivated by the fact that phenol normally exhibits weak adsorption on TiO₂ particles. PCO study is carried out in a cylindrical PCO reactor. The UV lamp used is a low pressure mercury UV lamp. The major emission of the UV lamp is 253.7 nm. An air pump is used to supply oxygen and create air bubbles for suspensions. TiO₂ microsphere is suspended in 1000 mL phenol solution in dark for 0.5 hours to attain well mixed condition before the PCO study set off. Samples are taken at different time intervals after UV light has been turned on. All samples are filtered through 0.45 μm membrane filters prior to the analysis.

FIG. 5 shows the results of this experiment. FIG. 5 shows the degradation of phenol as a function of the irradiation time at pH 7. It can be observed that the degradation of phenol followed an exponential decay form. Blank study (absence of photocatalyst) is carried out as a background check. About 40% of phenol is degraded after 60 min of UV light irradiation with the absence of the TiO₂ microsphere of the present invention. The removal efficiency is greatly enhanced when the TiO₂ microsphere of the present invention is added into the solutions. The removal efficiency after 60 min UV light irradiation is 60% and 70% for P25 TiO₂ and TiO₂ microsphere of the present invention, respectively. It is obvious that the TiO₂ microspheres possess a better photocatalytic activity than P25 TiO₂. C₀ shows the initial concentration in FIG. 5.

1. A method of manufacturing a titanium oxide microsphere having photocatalytic property and having a size of about 10 μm to about 200 μm and a mesoporous structure with a pore size in a range of about 2 to about 50 nm, wherein said method comprises:
preparing a sol by mixing an organometallic titanium precursor with an alcohol without adding H₂O;
aging said sol;
mixing said aged sol with titanium oxide powder;
spraying said mixture to form said titanium oxide photocatalyst microspheres; and
calcining said microspheres.

2. The method according to claim 1, further comprising adding a catalyst to said sol for initiating the reaction between said precursor and said alcohol.

3. The method according to claim 1, without adding polyethylenglycol to said sol.

4. The method according to claim 1, without adding amphipilic three-block copolymer to said sol.

5. The method according to claim 1, wherein the ratio of titanium organic precursor to alcohol is about 1 to between about 4 to 100 mol or about 1 to between about 40 to 60 mol.

6. The method according to claim 1, wherein said organic precursor is a titanium alkoxide.

7. The method according to claim 6, wherein said titanium alkoxide is selected from the group consisting of titanium methoxide, titanium ethoxide, titanium isopropoxide, titanium propoxide and titanium butoxide.

8. The method according to claim 1, wherein said alcohol is selected from the group consisting of ethanol, methanol, isopropanol, butanol and propanol.

9. The method according to claim 1, wherein said catalyst is selected from the group consisting of hydrochloric acid and nitric acid.

10. The method according to claim 1, wherein the pH is in a range of about 1 to about 4.

11. The method according to claim 1, wherein said aging is carried out for at least 24 hours.

12. The method according to claim 1, wherein for mixing said aged sol with titanium oxide powder the weight ratio of titanium oxide powder to aged sol is between about 1:3 to 1:10.

13. The method according to claim 12, wherein the weight ratio is about 1:5.

14. The method according to claim 1, wherein said microspheres are dried overnight at a temperature from about 50 to about 150° C. after spraying.

15. The method according to claim 1, wherein said calcination is carried out at a temperature of about 400° C. to about 600° C.

16. The method according to claim 1, wherein said calcination is carried out for about 3 to 6 hours.

17. The method according to claim 1, wherein the intercrystalline pore size distribution of the titanium oxide microspheres is 0.3.
